(19) United States
(12) Patent Application Publication
(10) Pub. No.: US 2020/0128310 A1
(43) Pub. Date: Apr. 23, 2020

(54) Systems and Methods Related to Voice Privacy

(71) Applicant: Gregory T. Umhoefer, Hartland, WI (US)

(72) Inventor: Gregory T. Umhoefer, Hartland, WI (US)

(21) Appl. No.: 16/720,780

(22) Filed: Dec. 19, 2019

Related U.S. Application Data
(63) Continuation-in-part of application No. 16/351,492, filed on Mar. 12, 2019.
(60) Provisional application No. 62/642,139, filed on Mar. 13, 2018.

(51) Int. Cl. H04R 1/02; H04R 1/08; H04R 1/10; H04R 5/033

(52) U.S. Cl. CPC H04R 1/02; H04R 1/08; H04R 2420/07; H04R 5/033; H04R 1/10

(57) ABSTRACT

System and method for voice privacy, the invention is directed to an apparatus positionable over a user's mouth configured to reduce the audible volume of the user's voice to other persons within a close proximity of the user and to reduce outside noise from entering the apparatus. The apparatus has a body, a gasket to make contact with a user's face, and a pocket in which a microphone portion of a pair of headphones is removably received.

### RELATED APPLICATIONS

This application is a continuation-in-part of co-pending U.S. patent application Ser. No. 16/351,492, filed Mar. 12, 2019, and entitled “Apparatus and Methods for Voice Privacy with Headphones,” which claims priority to U.S. provisional patent application No. 62/642,139, filed Mar. 13, 2018, and entitled “Systems and Methods for Voice Privacy,” both of which are incorporated herein by reference in their entireties.

### BACKGROUND OF THE INVENTION

With the prevalence of mobile phones and the all-too-common scenario of being in a public place and thrust into a stranger's personal business as she talks to a person on the other end, whether attempting to be discreet or not, or the situation in which an important call is coming through on your mobile phone and you are in a crowded subway car, the reality of having a private telephone conversation and reducing extraneous environmental noise is almost impossible.

There is prior art that attempts to allow a user to have a private telephone conversation while maintaining high sound quality or blocking extraneous environmental noise. For examples, see U.S. Pat. Nos. 7,783,034; 8,243,944; and 9,794,386 as well as U.S. Pat. App. No. 2002/0077838. The main problem with all of these examples is that they don't function with a user-supplied pair of headphones, which a significant percentage of mobile phone users carry or at least own.

Headphones with a microphone provide an advantage in that at least the voice of the person on the other side of the phone is being heard clearly, but the microphone is exposed to external noise and is as likely to pick up the conversation at the restaurant table next to you as it is your private discussion. However, it is impossible to have a private conversation with only a pair of headphones, as the user's voice can be heard by persons nearby.

Therefore, there is a need for a voice privacy apparatus configured to cover a user's mouth during a phone conversation, while recording a voice message, and/or delivering other communication or notes through speech-to-text that is configured to removably receive the microphone portion of a pair of headphones. An effective apparatus provides the following benefits: blocks extraneous environmental noise, reduces the audible volume of the user's voice to persons nearby, and still allows the user's own voice to be transmitted with a high level of audio quality.

### SUMMARY OF THE INVENTION

The present invention relates to an apparatus positionable over a user's mouth configured to reduce the audible volume of the user's voice to other persons within a close proximity of the user, to partially block outside noise from reaching the microphone, and to enable the microphone to pick up the user's voice with a high level of audio quality. The apparatus has an open-end which makes contact with a user's face and a pocket in which the microphone portion of a pair of headphones is removably receivable.

According to an aspect of an embodiment of a device according to the present invention, the device includes a shell defining a cavity, the shell including an exterior surface and a portal formed through the exterior surface, the portal sized and configured to selectively releasably receive and support a wireless microphone.

According to another aspect of an embodiment of a device according to the present invention, the shell includes a rim encircling the cavity, the device further comprising a gasket coupled to the rim. The shell may be formed from a first material and the gasket from a second material, the first material being different than the second material. The second material may have a lower hardness rating than the first material.

According to still another aspect of an embodiment of a device according to the present invention, the device may also include at least one air slot extending from the portal and formed through the exterior surface of the shell. The at least one air slot preferably includes two air slots extending from diametrically opposed positions of the portal.

According to yet another aspect of an embodiment of a device according to the present invention, the device may include a soundstem extending into the cavity, the portal extending into the soundstem. The device may further include a wireless microphone positioned within the soundstem, preferably spaced from an inner wall of the soundstem. The wireless microphone may be positioned on a free end of a stem portion of a wireless earphone. The shell may be formed from a first material and the soundstem from a second material, the first material being different than the second material. The second material may have a lower hardness rating than the first material.

According to a further aspect of an embodiment of a device according to the present invention, the shell may be a multi-piece shell, including an inner shell nested within an outer shell. While the soundstem may be formed integrally with the shell, if it is provided as a separate piece (e.g., from a material distinct from the shell), a soundstem mounting flange preferably extends radially outwardly from the portal, the mounting flange being at least partially sandwiched between the inner shell and the outer shell.

According to an aspect of a method according to the present invention, such method includes the steps of providing a microphone and a shell. The shell defines a cavity. The shell includes an exterior surface and a portal formed through the exterior surface, the portal sized and configured to selectively releasably receive and support the microphone. The method further comprises the steps of inserting the microphone into the portal and retaining the microphone in an at least substantially stationary position with respect to the shell. The method further comprises the steps of placing the cavity over an audio source and transmitting sound waves from the audio source to the microphone (or receiving sound waves from the audio source at the microphone). The audio source may include a human mouth.

According to another aspect of a method according to the present invention, the method may further include the step of placing the microphone in wireless communication with a communication device, such as a wireless telephone (e.g., smartphone) which has a wireless radio transceiver.

According to still another aspect of a method according to the present invention, the shell may include a rim encircling the cavity, the device further comprising a gasket coupled to the rim, wherein the placing step comprises the step of positioning the gasket in contact with facial epidermis about the mouth.

According to yet another aspect of a method according to the present invention, the microphone is a component of a first wireless earphone from a pair of wireless earphones, the method further comprising the step of visually matching a shape of the first wireless earphone to an outline shape index positioned stationarily with respect to the portal.

### BRIEF DESCRIPTION OF THE DRAWINGS

FIG. 1 is a perspective view of the voice privacy apparatus positioned on a user.

FIG. 2 is a bottom perspective view of the voice privacy apparatus shown in FIG. 1 with motion lines illustrating how the microphone portion of a pair of headphones is positioned in the apparatus.

FIG. 3 is a bottom perspective view of the voice privacy apparatus shown in FIG. 1 after the microphone has been positioned in the apparatus.

FIG. 4A is a front elevation view of the voice privacy apparatus shown in FIG. 1.

FIG. 4B is a cut-away view of the voice privacy apparatus shown in FIG. 4A along line 4B-4B.

FIG. 5 is a rear perspective view of the voice privacy apparatus shown in FIG. 1.

FIG. 6 is a bottom perspective view of a second embodiment of a voice privacy apparatus according to the present invention.

FIG. 7A is a rear elevation view of the embodiment of FIG. 6.

FIG. 7B is a cross-section elevation view taken along lines 7B-7B of FIG. 7A.

FIG. 8A is the view of FIG. 6, further including a wireless headphone in a first position relative to the voice privacy apparatus.

FIG. 8B is the view of FIG. 6, further including a wireless headphone in a second position relative to the voice privacy apparatus.

FIG. 9 is a bottom plan view of a third embodiment of a voice privacy apparatus according to the present invention.

FIG. 10A is a cross-section elevation view of the embodiment of FIG. 9.

FIG. 10B is a perspective cross-section view of the embodiment of FIG. 10A.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention, which is defined by the claims.

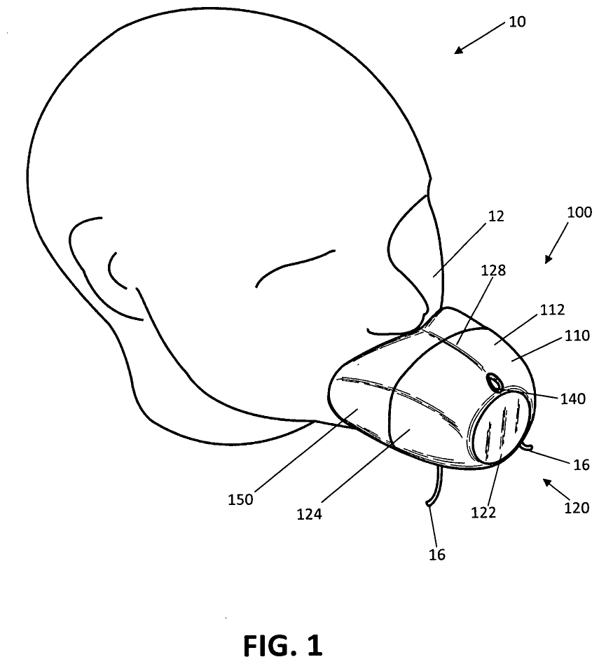

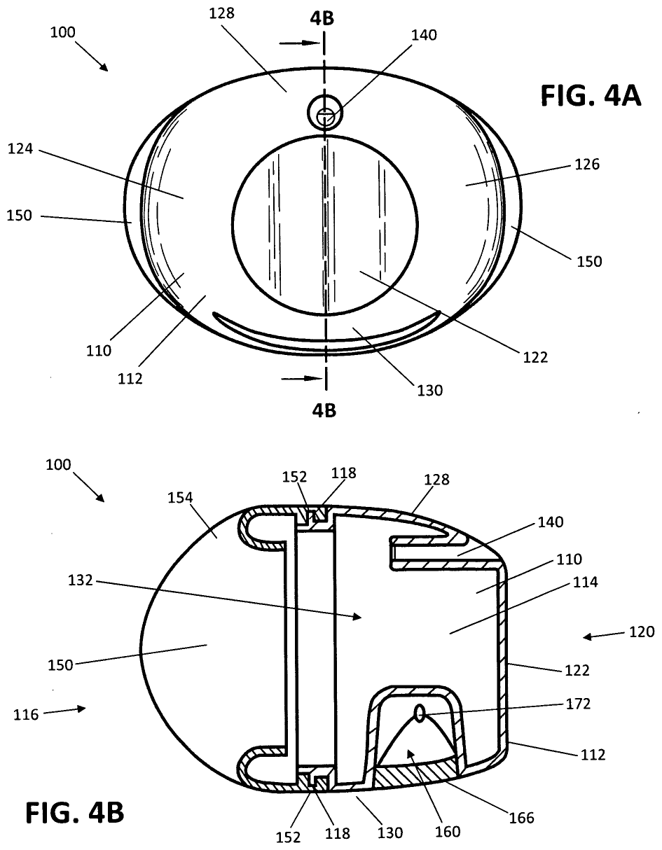

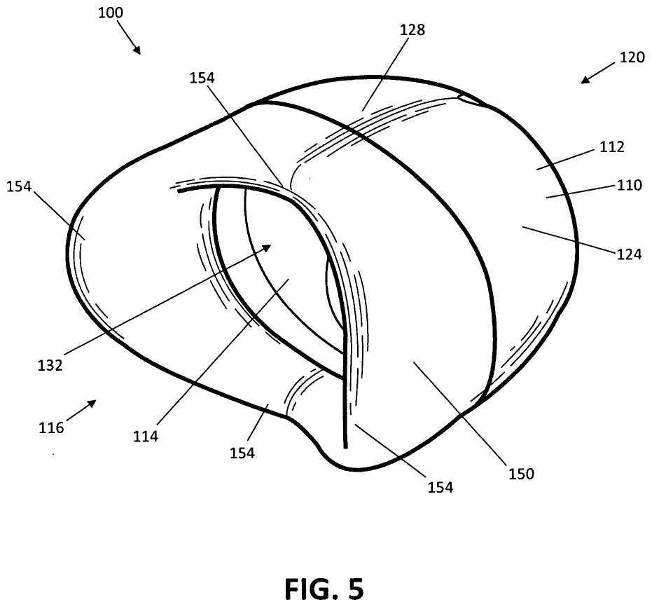

FIGS. 1-5 show an exemplary embodiment 100 of a voice privacy apparatus according to the present invention. The voice privacy apparatus 100 preferably comprises a body 110, a gasket 150, and a pocket 160.

The apparatus 100 has a substantially open-end portion 116 and a substantially closed-end portion 120. The open-end portion 116 is shaped and configured to follow the contours around the mouth (hidden) of a user 10 (see FIG. 1).

The body 110 is preferably dome-shaped having an exterior surface 112, an interior surface 114, a front side 122, a right side 124, a left side 126, a top side 128, and a bottom side 130, which, along with the gasket 150, define a cavity 132. The body 110 more preferably has a shape similar to that of an exterior elliptical dome with a substantially flat front side 122. The flat portion of the front side 122 is a convenient location for a logo or sticker, and also allows the apparatus 100 to be placed with the flat side down on a desk so that it will not roll around and also keep the open-end portion 116 free of crumbs or other desk debris. The flat portion of the front side 122 could also be used to affix a device (not pictured) which would allow the user 10 to more easily hold or grip the apparatus 100 using the fingers.

A tube 140 preferably extends inward from the exterior surface 112 at the front side 122 into the cavity 132. Preferably the ratio of the length of the tube 140 to the diameter of the tube 140 is approximately 8:1. For example, if the length is approximately one inch, the diameter will be approximately one eighth of an inch. The exemplary embodiment 100 has one tube 140, but other embodiments could have two or more tubes.

The gasket 150 preferably comprises a compliant material and is shaped to follow the rim 118 of the body 110. The gasket 150 preferably has a track 152 configured to receive the rim 118 and a flange portion 154 configured to provide cushion as a user 10 places the voice privacy apparatus 100 against the face 12 (see FIG. 1).

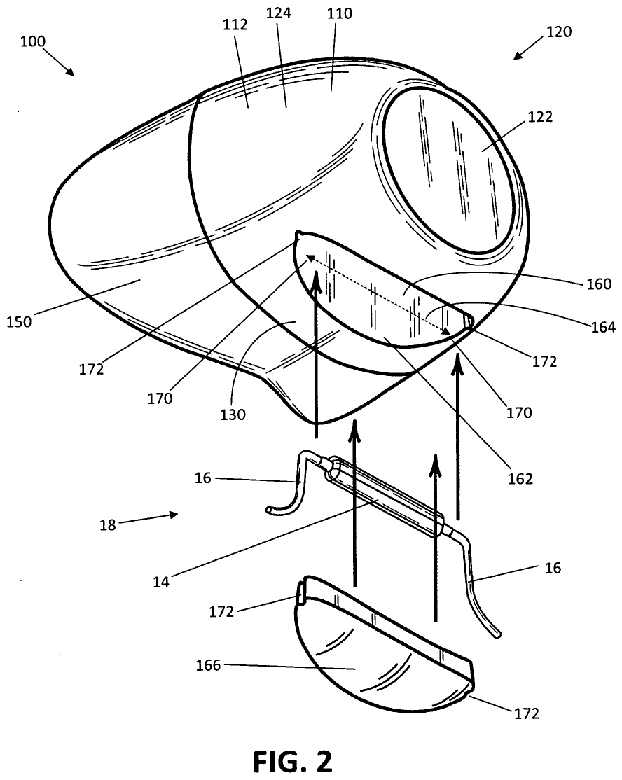

The pocket 160 preferably projects inward from the exterior surface 112 into the cavity 132 and has an open-end 162. The pocket 160 may comprise a compliant material (e.g., the same or similar material as that comprising the gasket 150); however, other materials are contemplated. The pocket 160 preferably has an interior elliptical shape with a long dimension 164 (see FIG. 2) extending along the bottom side 130 of the body 110. The transverse orientation of the pocket 60 across the bottom side 130 provides a convenient alignment with the microphone 14 of a user-supplied pair of headphones 18 as described further below.

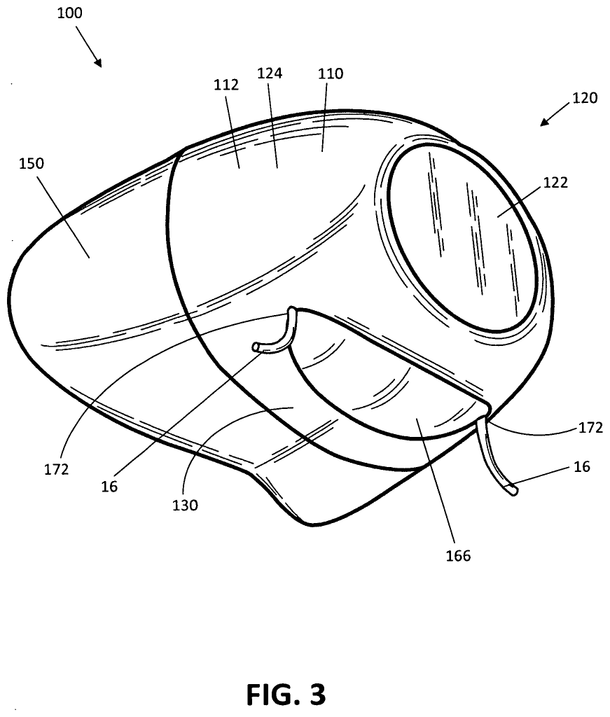

The pocket 160 further comprises a plug 166 that fits across the open-end 162 of the pocket 160. At each end 170 of the pocket 160 there is preferably a relief 172 sized and configured to retain a portion of a cord 16 on either side of the microphone 14 of the user-supplied pair of headphones 18 which permits the pocket 160 to close with an air-tight seal. With the pocket 160 closed (see FIG. 3), unwanted environmental noise is partially blocked and the microphone 14 is better able to pick up the voice of the user 10.

An example of user-supplied headphones 18 with a microphone 14 is EarPods™ headphones sold by Apple, Inc. in which the microphone portion is incorporated within the cord of the right earphone. Although the exemplary embodiment of the voice privacy apparatus 100 is described with the pocket 160 located on the bottom side 130 of the body 110 to accept the microphone portion of a pair of headphones like EarPods™ headphones, the pocket 160 may be located at any location and positioned in any manner on the apparatus 100 which allows for ease of reception of the microphone 14 of the user-supplied headphones 18.

A method of providing voice privacy is described as follows. Providing a voice privacy apparatus 100 having a body 110, a gasket 150, and a pocket 160. The apparatus 100 preferably has a substantially open-end portion 116 and a substantially closed-end portion 120. The body 110 and the gasket 150 define a cavity 132 into which one or more tubes 140 in the closed-end portion 120 extend to allow ventilation within the cavity 132. The gasket 150 is preferably comprised of a pliable material and positioned along a rim 118 of the body 110 and is configured to make contact with the face 12 of a user 10. The pocket 160 extends into the cavity 132 of the body 110 from the exterior surface 112 and has a plug 166 which is configured to enclose the microphone 14 of a user-supplied pair of headphones 18 to be received therein. Placing the microphone 14 of a user-supplied pair of headphones 18 into the pocket 160. Enclosing the microphone 14 using the plug 166 such that the cord 16 fits in the relief spaces 172 and an airtight seal is formed. Placing the voice privacy apparatus 100 around the mouth and the gasket 150 against the face 12 of a user 10. Speaking into the voice privacy apparatus 100.

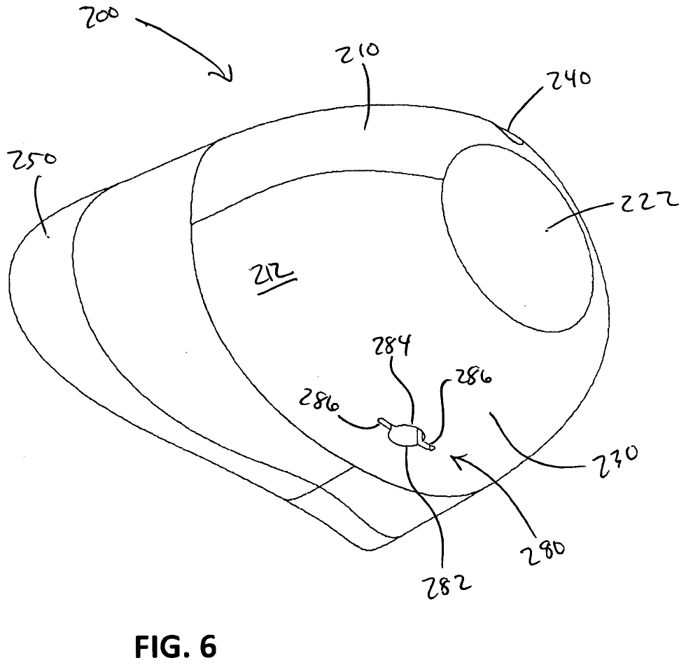

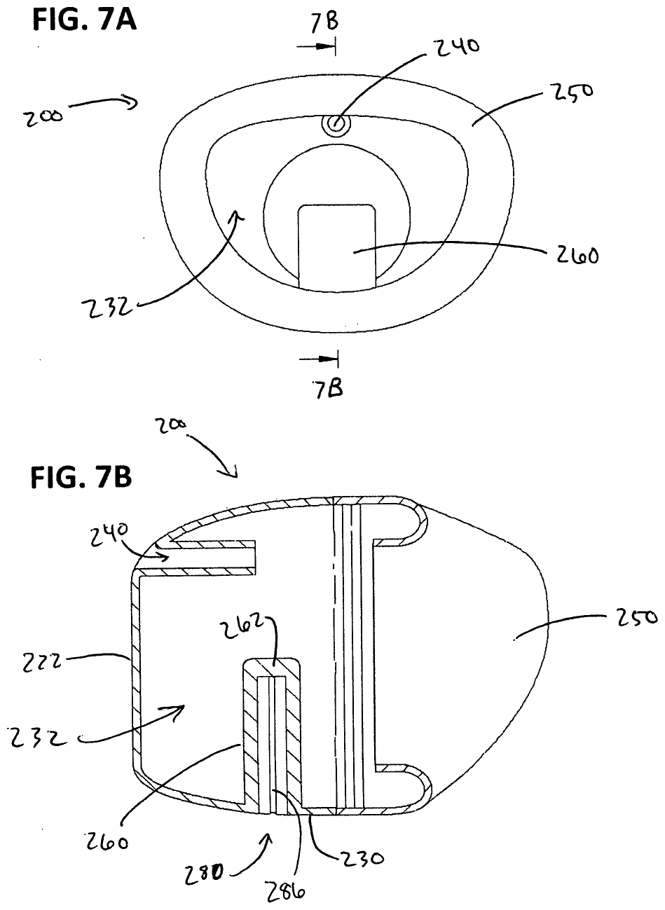

FIGS. 6-8B depict a second embodiment 200 of a voice privacy apparatus according to the present invention, which may be configured for use with wireless (in-ear) headphones (or earphones) that include microphone capabilities. The similar reference numbers used in connection with this second embodiment 200 (e.g., 212) refer to structure that is at least substantially similar or identical to structure discussed in connection with the first embodiment 100 (e.g., 112), unless specifically differentiated hereafter. Instead of the wired microphone interface (i.e., pocket and plug 160/166) of the first embodiment 100, this embodiment 200 includes a headphone interface 280 including a retention slot 282 formed through the exterior surface 212 of the body 210, such as through the bottom surface 230. Generally, the slot 282 preferably includes a headphone portal 284 flanked by opposing air slots 286. While a plurality of air slots 286 is shown extending from the portal 284, and a plurality is preferred, it is to be understood that a single air slot 286 (or no air slot) may be suitable. The retention slot 282 extends through the exterior surface 212 and into a soundstem 260 disposed in the cavity 232. The soundstem 260 is a substantially tubular member extending longitudinally from the open retention slot 282 to a closed end 262 disposed within the cavity 232. The retention slot 282 preferably extends along a majority of the longitudinal length of the soundstem 260, and more preferably extends into the cavity 232 from the exterior surface 212 for a length that is greater than an insertion length 32 of a wireless headphone 30. Thus, the soundstem 260 provides a preferably completely imperforate (from the cavity 232) housing for a microphone 34 that may be provided as a part of a wireless headphone 30. An example of a wireless headphone 30 that may be used in conjunction with this second embodiment 200 is an AirPod® headphone sold by Apple, Inc. in which the microphone portion 34 is incorporated at an end of a stem portion 36 of an earphone. In this embodiment 200, the soundstem 260 is provided as an integral extension (e.g., contemporaneously molded piece) of the body 210.

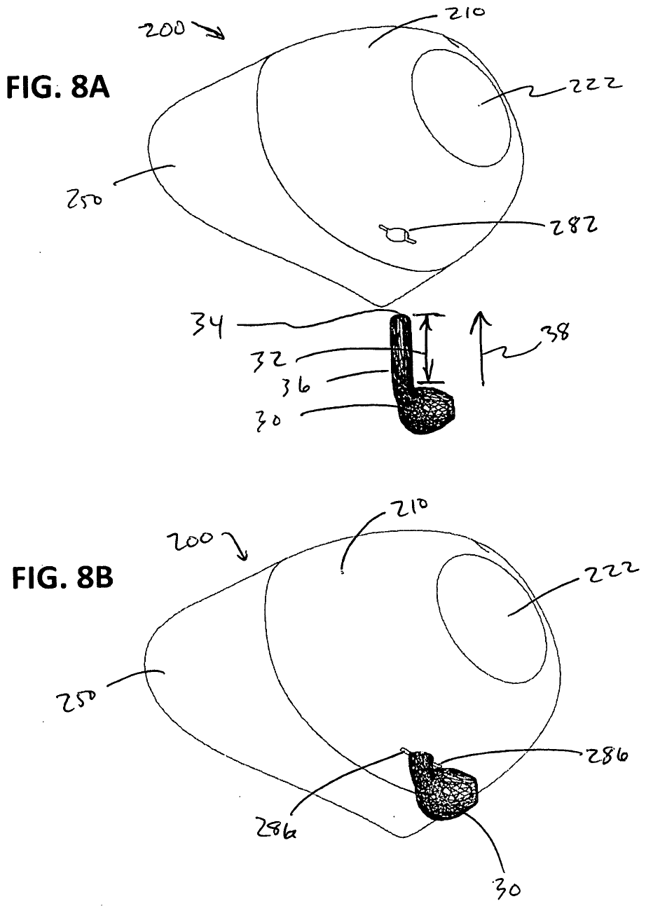

Referring more specifically to FIG. 8A and FIG. 8B, the second embodiment 200 is shown receiving an in-ear headphone 30. Generally, the earphone 30 includes a microphone 34 is incorporated on or at an end of a stem portion 36 of the earphone 30. The earphone 30 is manually aligned with the retention slot 282 and inserted therein in an insertion direction 38, which is preferably at least substantially parallel to the longitudinal direction of the soundstem 260. The earphone stem portion 36 is capable of being inserted along the entire insertion length 32 (i.e., until some portion of the earphone 30 abuts the exterior surface 212 outside the retention slot 282). The stem portion 36 frictionally engages the portal 284 to support and retain the earphone 30 in a relatively static position relative to the body 210. Indeed, the microphone 34 may be suspended within the soundstem 260 without touching any wall thereof. In this manner, in use, sound travels out of a user's mouth, through the cavity 232, through the soundstem 260, into the portal 284, and into the microphone 34 to be transmitted to an external communication device (not shown) (e.g., a mobile phone), such as by Bluetooth wireless connection.

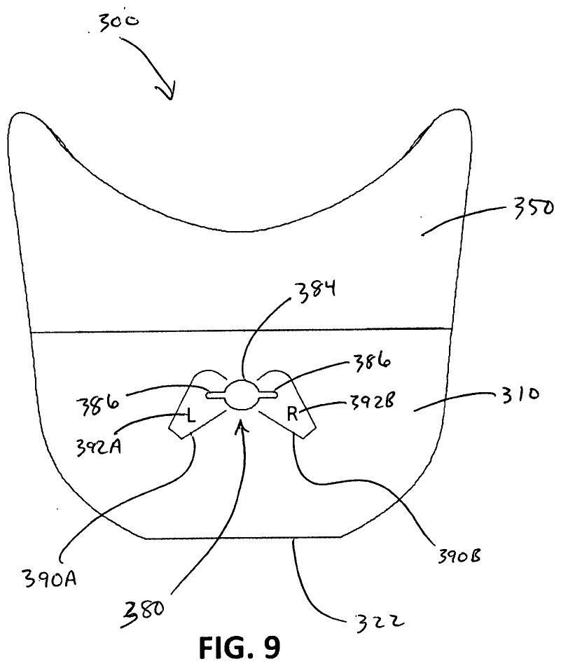

FIG. 9 depicts a third embodiment 300 of a voice privacy apparatus according to the present invention. The similar reference numbers used in connection with this third embodiment 300 (e.g., 312) refer to structure that is at least substantially similar or identical to structure discussed in connection with the first embodiment 100 (e.g., 112) and second embodiment 200 (e.g., 212), unless specifically differentiated hereafter. This embodiment 300 is similar to the second embodiment 200, further including earphone registration indices, such as graphical indices 390A,B and/or alpha-numeric indices 392A,B. As some wireless earphones 30 are programmable as to which earphone (left or right) in a pair includes an active or default microphone, it may be advantages to provide indicators to help more easily identify whether a user has inserted a proper earphone 30 to be used as a microphone. That is, a user may have programmed a right earphone (in a left-right pair) to operate as a microphone. A graphical index 390B may depict the outline of the correct earphone upon insertion into the portal 384. If the outline 390B does not match the shape of the inserted earphone 30, the user will know that the wrong earphone has been inserted, and may exchange it for the other of the pair. Alternatively, the left earphone may be left in place, and the programming may be changed such that the left earphone operates as a microphone. If the outline 390B matches the shape of the inserted earphone 30, then confirmation is provided to the user that the correct earphone 30 is in place for use as a microphone.

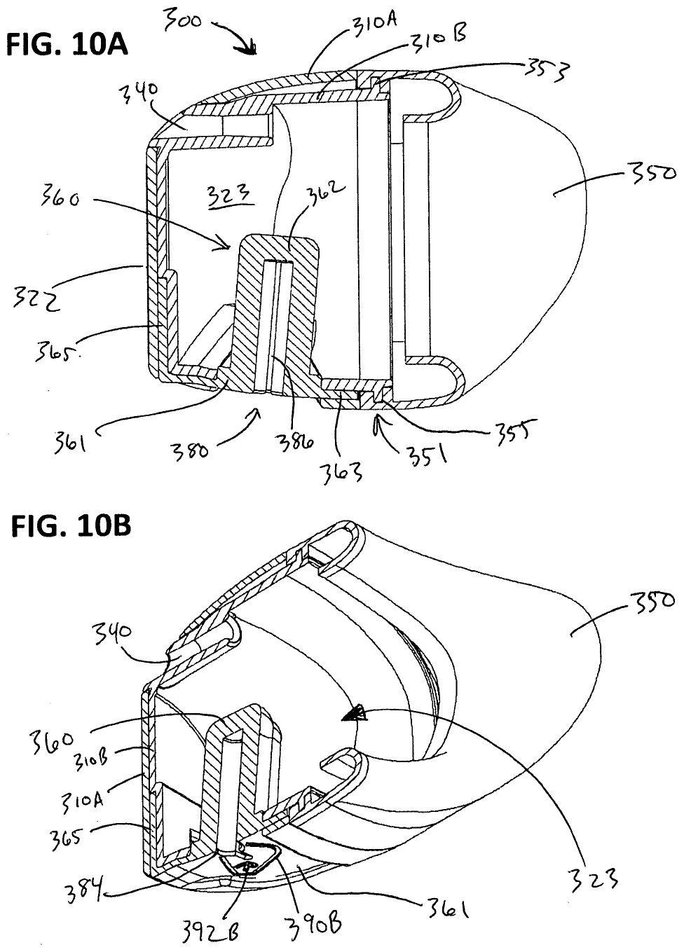

With respect to FIG. 10A and FIG. 10B, a cross-section of the third embodiment 300 may be seen. Rather than having a single-piece body, this embodiment 300 has a two-piece shell 310, including an outer shell 310A and an inner shell 310B. The two-piece design allows for a soundstem insert 361 to be made of a material that is different than the shell 310. For instance, the shell 310 may be constructed of a relatively rigid/hard plastic (e.g., Acrylonitrile Butadiene Styrene (ABS)), whereas it may desirable to have a soundstem of a softer (e.g., lower Shore hardness) material. A softer soundstem 360 may provide certain audio characteristics, but it also provides a more frictionally stable retention of an earphone stem inserted into the portal 384, making accidental dislodgement of the earphone 30 more difficult. The soundstem insert 361 includes a soundstem 360 and amounting flange 363 extending about the open end (i.e., portal 384). The mounting flange 363 (and forward mounting wall 365 extending from the flange 363) is at least partially sandwiched between the outer shell 310A and the inner shell 310B, and retained thereby. The shells 310A,B are then secured together, such as by adhesive or sonic welding. The gasket 350 preferably engages the inner shell 310B about a circumference of the cavity 323 in a mating relationship 351. For instance, the inner shell 310B may include a circumferential rib 353 extending radially outwardly and mateable with a circumferential groove 355 provided on the gasket 350. In this way, the gasket 355 may be relatively securely (or selectively removably) coupled to and supported by the body 310. Additionally or alternatively, the gasket 350 may be more permanently secured to the body 310, such as by adhesive. Use of this third embodiment 300 is the same as the second embodiment 200, which may have been improved with the addition of the registration indices 390A,B and/or 392A,B.

The foregoing is considered as illustrative only of the principles of the invention. Furthermore, because numerous modifications and changes will readily occur to those skilled in the art, it is not desired to limit the invention to the exact construction and operation shown and described. While the preferred embodiment has been described, the details may be changed without departing from the invention, which is defined by the claims.

What is claimed is:

1. A device comprising:
a shell defining a cavity, the shell including an exterior surface and a portal formed through the exterior surface, the portal sized and configured to selectively releasably receive and support a wireless microphone.

2. A device according to claim 1, the shell including a rim encircling the cavity, the device further comprising a gasket coupled to the rim.

3. A device according to claim 2, wherein the shell comprises a first material and the gasket comprises a second material, the first material being different than the second material.

4. A device according to claim 3, wherein the second material has a lower hardness rating than the first material.

5. A device according to claim 1, further comprising at least one air slot extending from the portal and formed through the exterior surface.

6. A device according to claim 5, wherein the at least one air slot comprises two air slots extending from diametrically opposed positions of the portal.

7. A device according to claim 1, further comprising a soundstem extending into the cavity, the portal extending into the soundstem.

8. A device according to claim 7, further comprising a wireless microphone positioned within the soundstem.

9. A device according to claim 8, wherein the wireless microphone is positioned on a free end of a stem portion of a wireless earphone.

10. A device according to claim 8, wherein the microphone is spaced from an inner wall of the soundstem.

11. A device according to claim 7, wherein the shell comprises a first material and the soundstem comprises a second material, the first material being different than the second material.

12. A device according to claim 11, wherein the second material has a lower hardness rating than the first material.

13. A device according to claim 7, the shell comprising an inner shell nested within an outer shell.

14. A device according to claim 13, further comprising a soundstem mounting flange extending radially outwardly from the portal, the mounting flange being at least partially sandwiched between the inner shell and the outer shell.

15. A method comprising the steps of:
providing a microphone;
providing a shell defining a cavity, the shell including an exterior surface and a portal formed through the exterior surface, the portal sized and configured to selectively releasably receive and support the microphone;
inserting the microphone into the portal;
retaining the microphone in an at least substantially stationary position with respect to the shell;
placing the cavity over an audio source; and,
transmitting sound waves from the audio source to the microphone.

16. A method according to claim 15, further comprising the step of placing the microphone in wireless communication with a communication device.

17. A method according to claim 16, wherein the communication device comprises a wireless radio transceiver.

18. A method according to claim 15, wherein the audio source is a human mouth.

19. A method according to claim 18, the shell including a rim encircling the cavity, the device further comprising a gasket coupled to the rim, wherein the placing step comprises the step of positioning the gasket in contact with facial epidermis about the mouth.

20. A method according to claim 15, wherein the microphone is a component of a first wireless earphone from a pair of wireless earphones, the method further comprising the step of visually matching a shape of the first wireless earphone to an outline shape index positioned stationarily with respect to the portal.
